(19) United States
(12) Patent Application Publication
(10) Pub. No.: US 2026/0185390 A1
(43) Pub. Date: Jul. 2, 2026

(54) METHOD FOR INSTALLING A PROFILED SECTION

(71) Applicant: Julius Blum GmbH, Hoechst (AT)

(72) Inventors: Stefan DUER, Schwarzach (AT); Lukas Schreiber, Feldkirch (AT); Kai Hollenstein, Fussach (AT); Matthias Jaeger, Dornbim (AT); André Hammerer, Alberschwende (AT)

(21) Appl. No.: 19/549,423

(22) Filed: Feb. 25, 2026

Related U.S. Application Data
(63) Continuation of application No. PCT/AT2024/060327, filed on Aug. 28, 2024.

(30) Foreign Application Priority Data
Sep. 4, 2023 (AT) A 50699/2023

(51) Int. Cl. E05D 15/26; E05D 15/58; E06B 3/50

(52) U.S. Cl. CPC E05D 15/264; E05D 15/58; E06B 3/5045; E05Y 2201/684; E05Y 2600/51; E05Y 2600/622; E05Y 2900/212

(57) ABSTRACT

Installing a profiled section on a support structure for a translational guide system includes: connecting a first profiled piece to a connecting device, the connecting device being integrally formed and/or being connected to the profiled piece at precisely one first fixation surface, and removing the first profiled piece from a storage device with the connecting device projecting beyond the longitudinal extension of the first profiled piece. The longitudinal extension of the first profiled piece with the connecting device thereon is maximally 1200 mm. An additional profiled piece with a longitudinal extension adapted to the total longitudinal extension of the profiled section is removed from a storage device and connected to the connecting device preinstalled on the first profiled piece, the longitudinal extension of the additional profiled piece equaling maximally 1200 mm. The first profiled piece and the additional profiled piece or the profiled section are arranged on the support structure.

The present application is a continuation of International Application PCT/AT2024/060327 filed on Aug. 28, 2024. Thus, all of the subject matter of International Application PCT/AT2024/060327 is incorporated herein by reference.

### BACKGROUND OF THE INVENTION

The invention relates to a method for installing a profiled section with a total longitudinal extension, preferably of at least 1200 mm, on a support structure for a translational guide system for a door assembly of a piece of furniture for covering another piece of furniture. The invention also relates to a profiled section for a support structure having a translational guide system for a door assembly of a piece of furniture for covering another piece of furniture. Furthermore, the invention relates to a piece of furniture having at least one such profiled section.

Such a method is already known from EP 3 622 148 B1, in which profiled pieces of a multi-part profiled piece are joined to form the profiled section via angle plates. For this purpose, two angle plates are installed on two profiled pieces and the two angle plates are connected to each other via a third angle plate in conjunction with T-nuts. One of the two angle plates is fixed to the first profiled piece via a first fixation surface. The second angle plate is then screwed to the second profiled piece using countersunk screws via two opposing fixation surfaces. After both angle plates have been installed, the two profiled pieces are brought into contact via the two angle plates, and then the third angle plate is inserted via a third fixation surface, which is oriented parallel to the two opposite fixation surfaces, and is also screwed in place using countersunk screws.

A disadvantage of the current prior art is that fixing the two profiled pieces requires a large number of installation steps and component parts, and requires free access to the profiled pieces in order to properly carry out the complex connection of the profiled pieces. Furthermore, the overall longitudinal extension of the profiled section is uniquely determined, so that the generated overall longitudinal extension of the profiled section may make it difficult or impossible to connect the profiled section to the support structure due to component tolerances in the manufacturing of the individual component parts.

### SUMMARY OF THE INVENTION

The objective technical object of the present invention is therefore to provide an method improved over the prior art and a profiled section, with which the disadvantages of the prior art are at least partially eliminated, and which is distinguished in particular by a particularly simple connection of the involved components, in particular by a fast preparatory and/or final installation and/or by a simple fixing mechanism.

Therefore, according to the invention, the following steps are carried out, preferably in chronological order:
a first profiled piece is connected to a connecting device in a preparatory step, wherein the connecting device is formed as a one-piece part and/or is connected to the first profiled piece at precisely one fixation surface,
the first profiled piece is removed from a storage device, preferably a transport pallet, together with the connecting device, which projects, preferably exclusively, in the longitudinal direction beyond a longitudinal extension of the first profiled piece and is preinstalled, preferably by means of at least one screw connection and/or in a detachable manner, wherein the longitudinal extension of the first profiled piece with the connecting device arranged thereon is a maximum of 1200 mm,
at least one additional profiled piece is removed from a storage device, preferably the storage device, with a longitudinal extension of the at least one additional profiled piece adapted to the overall longitudinal extension of the profile, and is connected, preferably via exactly one further fixation surface oriented coplanar to the first fixation surface, to the connecting device preinstalled on the first profiled piece, preferably by means of at least one screw connection and/or clamped by means of at least one clamping connection or plug connection, wherein the longitudinal extension of the at least one additional profiled piece is a maximum of 1200 mm, wherein it is preferably provided that a further preinstalled connecting device is arranged on the at least one additional profiled piece,
the first profiled piece and the at least one additional profiled piece or the profiled section is arranged on the support structure.

This makes it possible to efficiently and easily segment the profiled section into the desired overall longitudinal extension before or during the final assembly of the profiled section on the support structure, using a modular system, wherein different overall longitudinal extensions can be covered by a limited number of profiled pieces, and at the same time the transport of the profiled section can be simplified in a resource-saving manner.

In addition, there is the positive feature that final installation can be carried out particularly simply, user-friendly and quickly, since access for connection is only required via a fixation surface. Therefore, the accessibility of one side surface of the profiled section is sufficient for the assembly of the profiled section. This offers the advantage that the profiled section can be used in a wide range of applications—especially on parts of a piece of furniture that are visible in use, while maintaining a simple aesthetic overall impression, which is of significant importance to the user of the piece of furniture.

Furthermore, the connection of the profiled pieces via the connecting device is not complex and requires a small number of component parts and processing steps, with a small number of required installation steps and no specialist personnel are needed for installation.

The preinstalled connecting device can be taken into account in the longitudinal extension of the first (or additional) profiled piece, so that standard pallets can be used for transport. A wide product range can be covered by an advantageous selection of longitudinal extensions of the first and additional profiled piece(s), wherein the number of longitudinal extensions of the profiled pieces required for this purpose can remain low.

The profiled section can be arranged successively by arranging the profiled pieces on the support structure or as a whole on the support structure next to each other. The profiled section can be formed via the connecting device, whereby the number of connecting devices and/or profiled pieces for forming the profiled section is not limited.

The profiled pieces should preferably be at least 500 mm long. Preferably, at least one screw connection for the additional profiled piece is already preinstalled on the connecting device during the transport of the segmented profile, so that the screw connection only needs to be tightened during final assembly. However, the fixing of the connecting device is generally not limited to screw connections and/or clamp connections and/or plug connections, wherein adhesive connections for attaching the connecting device are also conceivable.

In the context of the invention, “preinstalled” is to be interpreted so broadly that it also includes a material-bonded connection between the connecting device and the profiled piece.

It is not absolutely necessary that the profile, in its assembled state, is positioned with its entire longitudinal extension on the support structure; the entire longitudinal extension can, for example, also be formed successively on the support structure.

As stated at the outset, protection is also sought for a profiled section for a support structure with a translational guide system for a door assembly of a piece of furniture for concealing another piece of furniture, wherein the profiled section has a total longitudinal extension, preferably of at least 1200 mm, wherein the profiled section comprises a first profiled piece with a connecting device, preferably exclusively, projecting longitudinally beyond a longitudinal extension of the first profiled piece and preinstalled, preferably by means of at least one screw connection and/or detachably, wherein the longitudinal extension of the first profiled piece with the connecting device arranged thereon is a maximum of 1200 mm and the connecting device is formed as a one-piece part and/or is connected to the first profiled piece at exactly one first fixation surface, and comprising at least one additional profiled piece with a longitudinal extension of the at least one additional profiled piece adapted to the total longitudinal extension of the profile, wherein the at least one additional profiled piece with the connecting device preinstalled on the first profiled piece is preferably connected via exactly one further fixation surface oriented coplanar to the first fixation surface, preferably by means of at least one screw connection and/or clamped by means of at least one clamping connection or plug connection, wherein the longitudinal extension of the at least one additional profiled piece is a maximum of 1200 mm, wherein it is preferably provided that a further preinstalled connecting device is arranged on the at least one additional profiled piece.

As stated at the outset, protection is also sought for a piece of furniture comprising a support structure, a translational guide system arranged on the support structure, a door assembly installed to be movable relative to the guide system for concealing an additional piece of furniture and at least one such profiled section.

According to an advantageous embodiment of the invention, the first profiled piece is positioned with a butt joint with the adjacent additional profiled piece and/or two adjacent additional profiled pieces.

The term “butt joint” in this context means that the end surfaces of the profiled pieces involved are flush and oriented with parallel butt planes to each other. This results in a particularly appealing visual appearance.

Preferably, the connecting device contacts the profiled section on a maximum of three, two, or one side surface, so that the profiled section is only slightly affected visually by the connecting device or not affected at all in the visible region.

Advantageously, the total longitudinal extension of the profiled section is at least 2400 mm and the profiled section is formed from at least, preferably exactly, three profiled pieces, at least two of the at least three profiled pieces preferably comprising a preinstalled connecting device.

The longitudinal extensions of the at least three profiled pieces can be chosen depending on the total longitudinal extension such that a small and/or discrete number of profiled pieces are required and/or this number of profiled pieces (possibly in combination with further discrete longitudinal extensions of profiled pieces) can also be used for other extensions of the total length.

By combining profiled pieces of different lengths, a wide range of overall longitudinal extensions can be covered. Total longitudinal extensions above 1200 mm can be covered with different profiled pieces, wherein the profiled pieces can generally have different longitudinal extensions. For example, a total longitudinal extension of 2000 mm—for example, to reduce the number of required profiled pieces—can be formed by two profiled pieces with a length of 1000 mm, or by one profiled piece with 800 mm in combination with one profiled piece with 1200 mm, or by one profiled piece with 1000 mm in combination with two profiled pieces with 500 mm each, or with 300 mm and 700 mm.

It has proven advantageous that at least one of the profiled pieces and/or the at least one connecting device has at least one longitudinally oriented elongated hole, wherein the at least two profiled pieces are positioned relative to each other via the at least one elongated hole in such a way that a predefined overall longitudinal extension of the profiled section results.

The inclusion of at least one elongated hole allows for length compensation and/or play compensation to precisely adjust the overall longitudinal extension and/or to simplify the installation process.

According to an advantageous embodiment of the invention, it is provided that the at least one connecting device is arranged on one of the profiled pieces via at least one self-threading screw, preferably with a toothed underhead, and/or at least one dowel pin and/or at least one embossed stud as a centering lug, wherein it is preferably provided that at least one profiled piece and/or the at least one connecting device comprises at least one opening for chip release for the at least one self-threading screw.

For example, eight bores or holes with five preinstalled threaded screws for aligning the profiled pieces can be provided for attaching the connecting device in the profile section, but the type or number of connecting means is not limited.

An advantageous embodiment of the present invention consists in the fact that the at least two profiled pieces are aligned orthogonally to the longitudinal direction via at least two protrusions on the at least one connecting device and/or via at least one elongated hole oriented orthogonally to the longitudinal direction.

The at least one elongated hole and/or the protrusions can be used to compensate for tolerances of the component parts involved in the fixing and/or to simplify an installation process.

Preferably, the at least one connecting device is inserted into the at least two profiled pieces without tools and/or a U-profiled shape of the at least two profiled pieces is supported by the at least one connecting device.

In one embodiment of the invention, the profiled section is arranged in the form of a guide rail for movement of the door assembly transversely to a receiving shaft of the support structure, or a hinge strip for a hinge support of the support structure, or a hinge support for connecting a hinge strip to the support structure, or a cover strip for covering a guide rail, or a hinged cover for partially covering a receiving shaft of the support structure and/or a gap of the door assembly on the support structure.

According to a preferred embodiment of the invention, the at least one connecting device is essentially plate-shaped and/or metallic or made of plastic, and preferably the at least one connecting device comprises a Z-shaped bend.

Preferably, the at least one connecting device is essentially cuboid in shape and/or made of plastic or metal.

Furthermore, preferably the at least two profiled pieces and/or the at least one connecting device is designed in the form of a U-shaped plate, and preferably wherein the sheet comprises legs of different heights and/or at least one conical embossing.

The conical embossing can be used, for example, for lateral support of the connecting device on the profiled section and to achieve a firm connection of the profiled pieces (especially with bidirectional positive locking in the transverse direction).

In a further embodiment, at least one support device and/or at least one spacer sleeve is provided within the sheet metal. A support device or a spacer sleeve can prevent the profiled section from deforming undesirably during installation.

According to an advantageous embodiment of the invention, the profiled section is designed as a guide rail for a carriage for moving the door assembly along the guide system.

A revolving door or a folding sliding door can be moved along the piece of furniture via the guide rail, preferably via a translationally moving carriage in the direction of a receiving shaft or in a direction transverse to the receiving shaft.

According to a preferred embodiment of the invention, the profiled section is designed as a hinge strip for connecting the door assembly to a hinge support of the guide system.

Preferably, the hinge strip comprises at least one, in particular at least two, three or four hinges spatially spaced apart from each other in the vertical direction in the state of use, for fixing the door assembly to the hinge strip. The hinge strip is particularly preferably arranged on the support structure indirectly via the hinge support.

Preferably, the profiled section is designed as a hinge support for connecting a door assembly or a hinge strip to the guide system.

Preferably, the profiled section is designed as a cover strip for covering the guide system, wherein it is preferably provided that the cover strip comprises at least one holding device with a locking mechanism for connecting the cover strip to a running rail.

The cover strip allows the running rail and/or a carriage to be at least partially concealed.

According to one exemplary embodiment, the profiled section is designed as a hinged cover to at least partially cover a receiving shaft of the support structure and/or a gap in the door assembly.

The hinged cover can conceal a gap in the door assembly, which may be caused by a folded position of the door assembly (preferably in the form of a folding sliding door), and/or cover the receiving shaft of the support structure for the door assembly, at least partially, when the door assembly is folded.

### BRIEF DESCRIPTION OF THE DRAWINGS

Further details and advantages of the present invention will be explained in more detail below with reference to the drawings. The technical features of a constructive design of an embodiment—in particular the connecting device—are applicable alternatively or additionally in the further embodiments. In the drawings:

FIG. 1 shows a piece of furniture according to a preferred exemplary embodiment with profiled sections according to preferred embodiments in a perspective view,

FIGS. 2 to 4 show a profiled section according to a preferred embodiment in the form of a hinge support with a U-shaped connecting device in a perspective view, in orthogonal views and in sectional views,

FIG. 5 shows the profiled section according to the exemplary embodiment according to FIG. 2 in representations to visualize the fixing of the connecting device with two varying geometries of connecting devices,

FIGS. 5, 6 show a profiled section according to further preferred embodiments in the form of hinge strips before the fixing of an additional profiled section part and before the connection of a connecting device in perspective views,

FIGS. 7 to 11 show different embodiments of connecting devices and hinge strips for forming a profiled section,

FIG. 12 shows three varying connecting devices for coupling profiled pieces of a cover strip, each in perspective view and two orthogonal representations,

FIGS. 13 and 14 show three varying connecting devices for coupling profiled pieces of a hinged end, each in two orthogonal representations and in perspective view,

FIG. 15 shows two cross-sectional views of profiled sections, one profiled section being a cover strip and the other a hinged end.

### DETAILED DESCRIPTION OF THE INVENTION

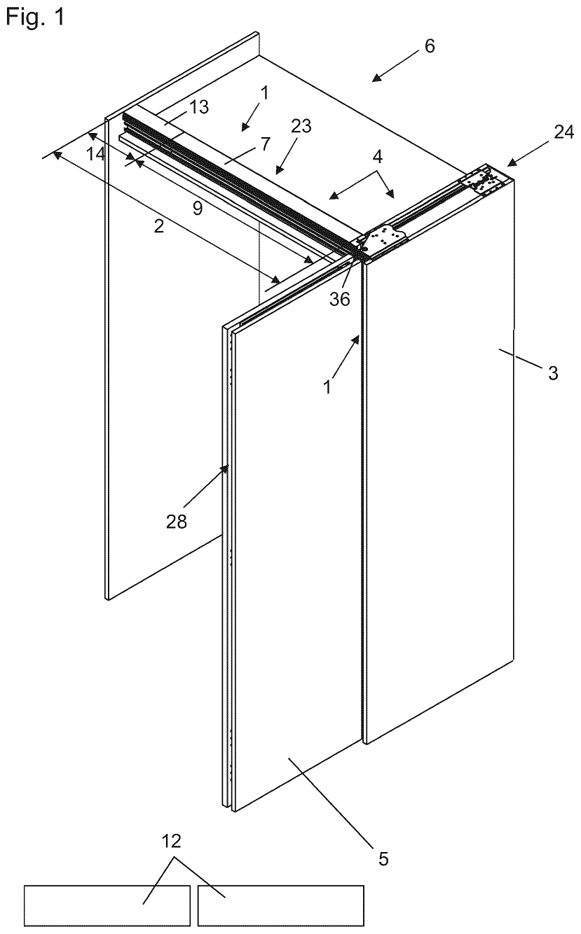

FIG. 1 shows a piece of furniture 6 comprising a support structure 3, a translational guide system 4 arranged on the support structure 3, and a door assembly 5 installed to be movable relative to the guide system 4 in order to be able to conceal other furniture.

The piece of furniture 6 comprises five profiled sections 1 with a total longitudinal extension 2 of at least 1200 mm, which were installed on the support structure 3.

A profiled section 1 is in the form of the running rail 23 for a carriage 36 for moving the door assembly 5 along the guide system 4.

A profiled section 1 is provided as a hinge strip 25 for connecting the door assembly 5 to a hinge support 26 of the guide system 4, wherein the hinge strip 25 is concealed by the door assembly 5 in the illustration.

A profiled section 1 is provided as a hinge support 26 for connecting the door assembly 5 or the hinge strip 25 to the guide system 4, wherein the hinge support 26 is concealed by the door assembly 5 in the illustration.

A profiled section 1 is provided as a cover strip 27 for covering the guide system 4, wherein the cover strip 27 is not visible in this illustration in order to visualize the running rail 23 with two segments. The cover strip 27 can generally be clipped onto the running rail 23 using retaining devices with a snap-fit mechanism for connecting the cover strip 27 to the running rail 23.

A profiled section 1 is in the form of a hinged cover 28 for partially covering a receiving shaft 24 in a folded position of the door assembly 5 of the support structure 3 and a gap of the door assembly 5, wherein the receiving shaft 24 is formed by two vertical furniture panels into which the door assembly 5 can be moved translationally, and the hinged cover 28 is concealed by a door leaf of the door assembly 5.

An exemplary method for installing one of the profiled sections 1 on the support structure 3 can be explained as follows: A first profiled piece 7 (preferably the running rail 23, the hinge strip 25, the hinge support 26, the cover strip 27 or the hinged cover 28) is connected in a preparatory step to a connecting device 11, wherein the connecting device 11 is integrally formed and is connected to the first profiled piece 7 at exactly one first fixation surface 38. The first profiled piece 7 is removed from a storage device 12, in the form of a transport pallet, together with the connecting device 11, which excursively projects in the longitudinal direction beyond a longitudinal extension 9 of the first profiled piece 7 and is preferably preinstalled by means of at least one screw connection 10 in a detachable manner, wherein the longitudinal extension 9 of the first profiled piece 7 with the connecting device 11 arranged thereon is a maximum of 1200 mm. An additional profiled piece 13 is removed from the storage device 12 with a longitudinal extension 14 of the additional profiled piece 13 adapted to the total longitudinal extension 2 of the profiled section 1 and connected to the connecting device 11 preinstalled on the first profiled piece 7 via exactly one further fixation surface 39 oriented coplanar to the first fixation surface 38 to form the profiled section 1, wherein the longitudinal extension 14 of the additional profiled piece 13 is a maximum of 1200 mm. The connection between connecting device 11 and profiled section 1 is preferably made via at least one screw connection 10, wherein in general at least one clamping connection 15 or plug connection or the like can be used alternatively or additionally for fixing the connecting device 11. The profiled section 1 is arranged on the support structure 3, wherein it is generally irrelevant whether the profiled section 1 is successively installed on the support structure 3 or completed during the installation on the support structure 3, or whether the profiled section 1 is first completed and then installed on the support structure 3 with its total longitudinal extension 2.

In general, the method can also be used to install profiled sections 1 with a total longitudinal extension 2 of less than 1200 mm. The method is particularly suitable for large overall longitudinal extensions 2, especially above 2400 mm, wherein preferably at least three profiled pieces 7, 13 are used, wherein a preinstalled connecting device 11 is arranged on the first profiled piece 7 and on the additional profiled piece 13, and the profiled pieces 7, 13 with preinstalled connecting device 11 do not exceed a dimension of 1200 mm in order to facilitate or make transport more efficient.

It is generally possible that two connecting devices 11 (preferably with a maximum dimension of 1200 mm) are preinstalled on the first profiled piece 7 (or the additional profiled piece 13), wherein two additional profiled pieces 13 are connected via the two connecting devices 11.

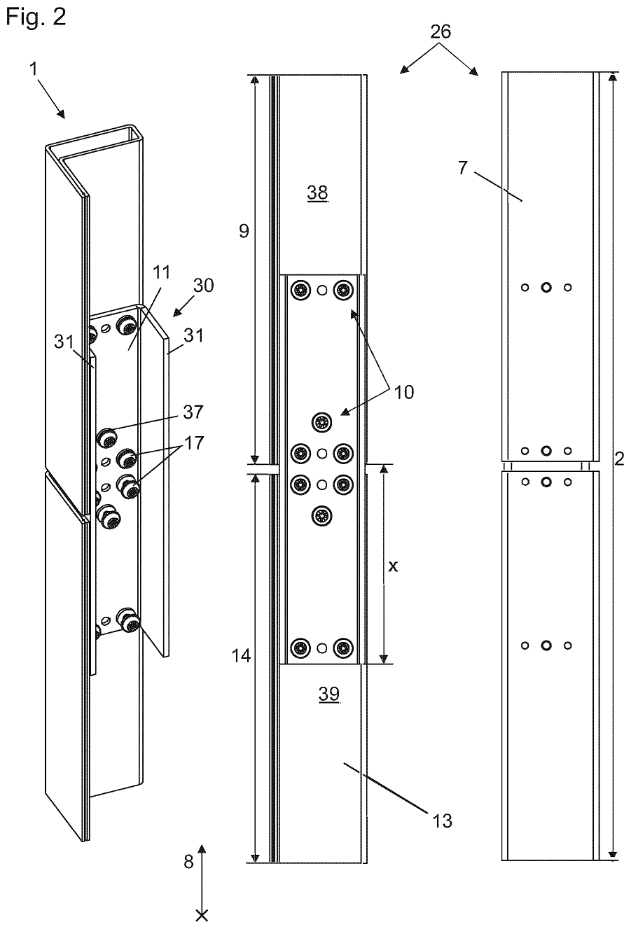

FIG. 2 shows the profiled section 1 in the form of a hinge support 26, wherein the hinge support 26 is formed from two profiled pieces 7, 13. Similarly, profiled section 1 can consist of several profiled pieces 7, 13. The hinge support 26 is arranged on the support structure 3 and can be provided for connection with a hinge strip 25 for connecting the door assembly 5 to the support structure 3.

The profiled section 1 has a total longitudinal extension 2 between 1200 mm and 2200 mm, where the total longitudinal extension 2 is generally arbitrary. The profiled section 1 comprises a first profiled piece 7 with a preinstalled connecting device 11 (in the state disassembled or assembled from the additional profiled piece 13) projecting exclusively in the longitudinal direction 8 beyond a longitudinal extension 9 of the first profiled piece 7, wherein the longitudinal extension 9 of the first profiled piece 7 with the connecting device 11 arranged thereon is a maximum of 1200 mm in order to be arranged on a conventional Euro pallet for shipping purposes.

The connecting device 11 is detachably arranged on the first profiled piece 7 by means of screw connections 10, wherein the number of screw connections 10 is generally arbitrary.

The connecting device 11 is integrally formed and in this embodiment is in the form of a U-shaped sheet 30.

The connecting device 11 is connected to the first profiled piece 7 at exactly one first fixation surface 38 via the screw connections 10 (fixation can generally also be effected by a clamping connection 15 or plug connection or the like), wherein the first fixation surface 38 corresponds to a side surface of the first profiled piece 7.

According to this embodiment, profiled section 1 comprises an additional profiled piece 13 with a longitudinal extension 14 of the additional profiled piece 13 that is adapted to the total longitudinal extension 2 of profiled section 1.

The additional profiled piece 13 is connected to the connecting device 11 preinstalled on the first profiled piece 7 to form the profiled section 1. If the profiled section 1 comprises at least 3 profiled pieces 7, 13, two connecting devices 11 can be preinstalled on two of these profiled pieces 7, 13 or both connecting devices 11 can be preinstalled on one of these two profiled pieces 7, 13.

The connecting device 11 is screwed to the additional profiled piece 13 via exactly one further fixation surface 39 oriented coplanar to the first fixation surface 38 on the profiled section 1 by means of screw connections 10.

It is also possible, for example, to fix the connecting device 11 to the first profiled piece 7 via at least one screw connection 10 and to the additional profiled piece 13 via at least one clamp connection 15 or plug connection.

The longitudinal extension 14 of the additional profiled piece 13 is less than 1200 mm and if a further connecting device 11 is arranged on the additional profiled piece 13, in this exemplary embodiment the longitudinal extension 14 of the additional profiled piece 13 together with the projection of the connecting device 11 in longitudinal direction 8 is at most 1200 mm.

Five of the screw connections 10 are preinstalled, with the remaining five screw connections 10 being tightened during final assembly. Preferably, the remaining five screw connections 10 are already preinstalled on the preinstalled connecting device 11, so that the fitter only has to provide a sufficient tightening torque or can use the preinstalled screw connections 10 as an assembly aid.

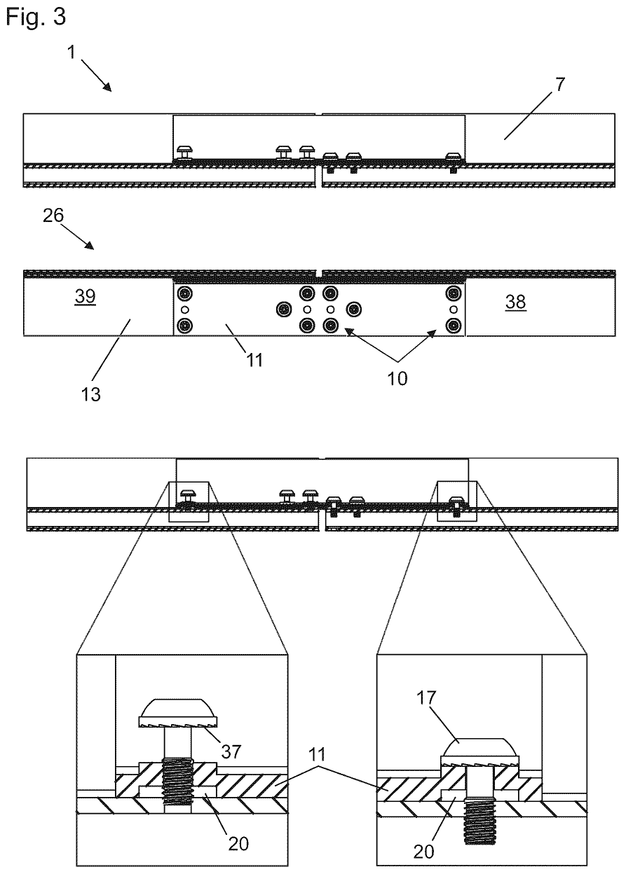

FIG. 3 shows the profiled section 1 as hinge support 26 in sectional view from the side and from above, wherein the detail cutouts show that the connecting device 11 is arranged on the profiled pieces 7, 13 via self-threading screws 17 with underhead teeth 37.

The connecting device 11 includes openings 20 for chip release for the screws 17.

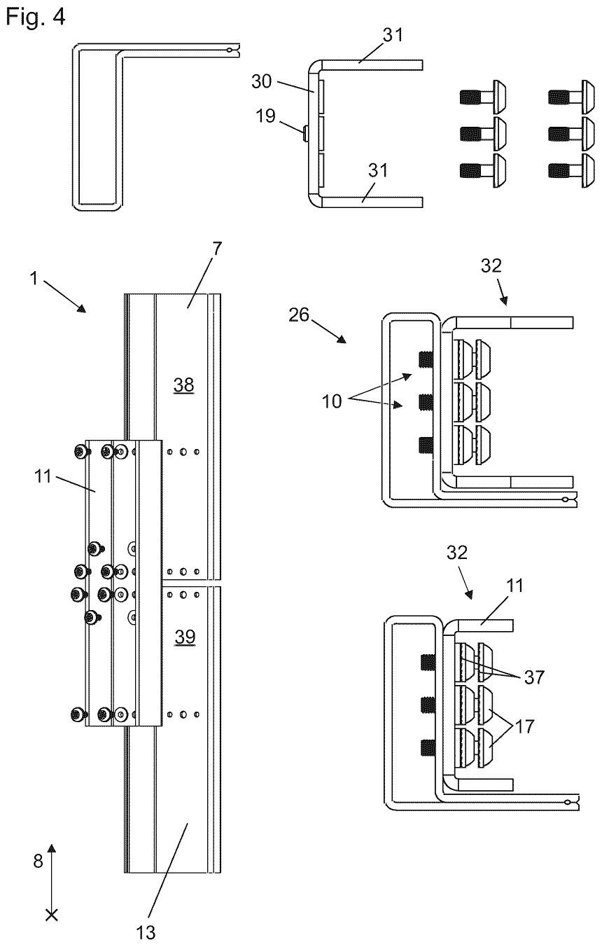

FIG. 4 illustrates the hinge support 26 in an exploded view as well as during the installation process.

The connecting device 11 in the form of the U-shaped sheet 30 has two legs 31, wherein the legs 31 of the sheet 30 in the lower right of the illustration have a lower height 32 than the legs 31 of the sheet in the middle of the illustration on the right, in order to be able to provide a door assembly 5 in the form of a folding sliding door and a door assembly 5 in the form of a hinged door on the piece of furniture in a particularly convenient way.

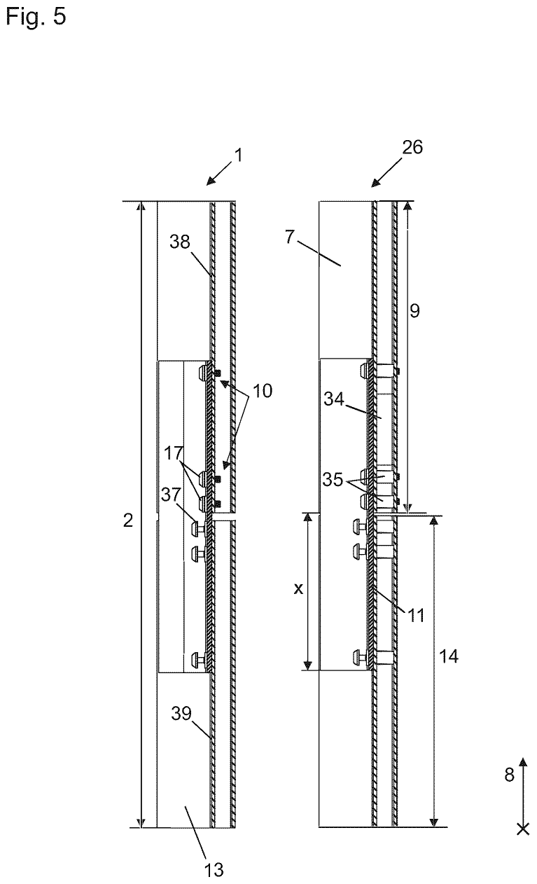

FIG. 5 shows that the hinge support 26 can include support devices 34 (schematically indicated in dotted line) or spacer sleeves 35 within the sheet 30 to increase the stability of the profiled section 1.

The projection of the connecting device 11 on the first profiled piece 7 is indicated by “X”, which must generally be taken into account when measuring for transport.

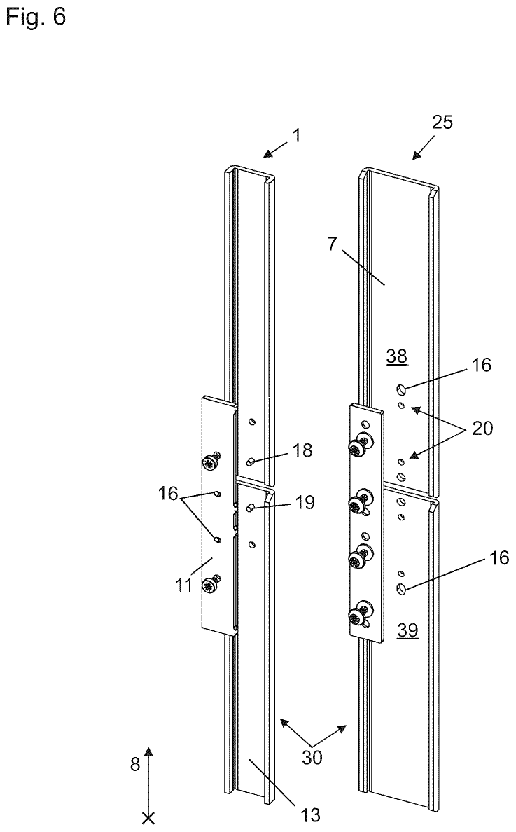

FIG. 6 shows two profiled sections 1 in the form of hinge strips 25, each of which can be attached to the hinge support 26 to accommodate a door assembly 5.

The first two profiled pieces 7 and two additional profiled pieces 13 are provided as a U-shaped sheet 30.

The connecting device 11 in the left illustration is fixed according to this embodiment with two screw connections 10, wherein one of the two screw connections 10 is preinstalled on the first profiled piece 7 and the second screw connection 10 can be preinstalled on the connecting device 11.

The connecting device 11 comprises two elongated holes 16, which are oriented orthogonally to the longitudinal direction 8.

For connecting the connecting device 11, an extension can be used which can be used as a dowel pin 18 or embossing stud 19 to form a centering lug.

The connecting device 11 in the right-hand illustration can be positioned via elongated holes 16 oriented in the longitudinal direction 8 of the profiled pieces 7, 13 for adjusting the desired orientation of the profiled pieces 7, 13.

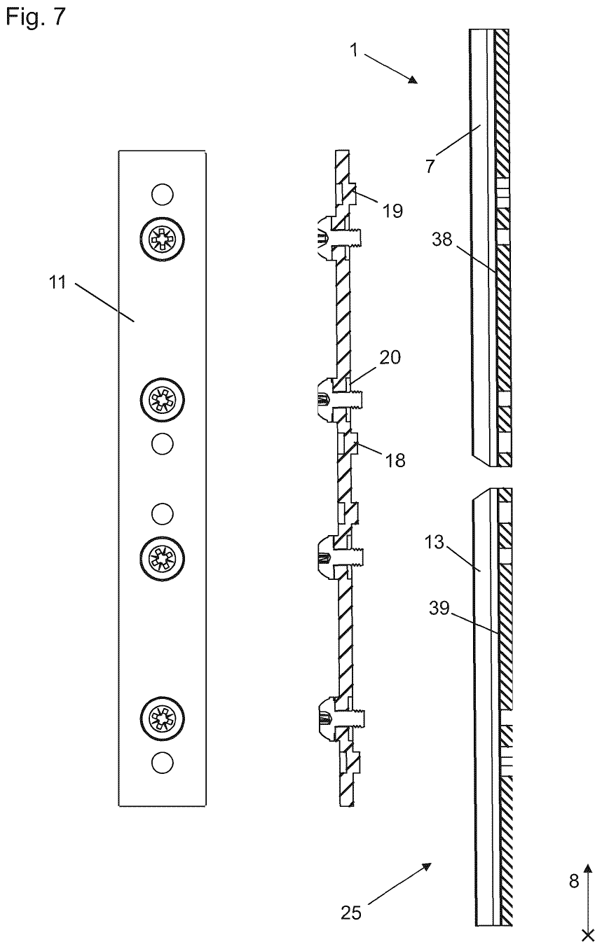

FIG. 7 shows the involved component parts of the hinge strip 25 in sectional view, wherein the connecting device has extensions which can be used as dowel pins 18 or as embossing studs 19.

The connecting device 11 includes openings 20 for chip release for the self-threading screws 17.

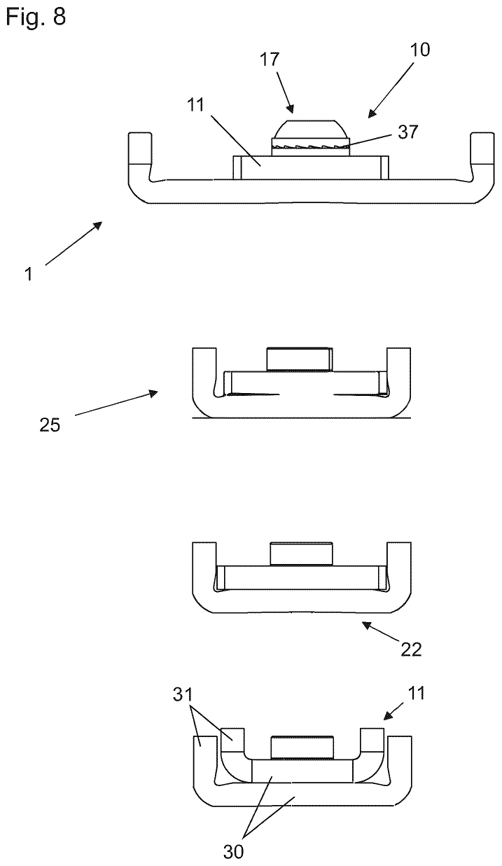

FIG. 8 shows varying connections of hinge strips 25 via connecting devices 11, wherein, for example, different screw connections 10 or different geometries of the profiled section 1 or the connecting device 11 may be provided.

For example, the connecting device 11 in the lower illustration is in the form of a U-shaped sheet 30, whereas the connecting devices 11 in the upper illustrations are designed in a plate-like form—made of metal.

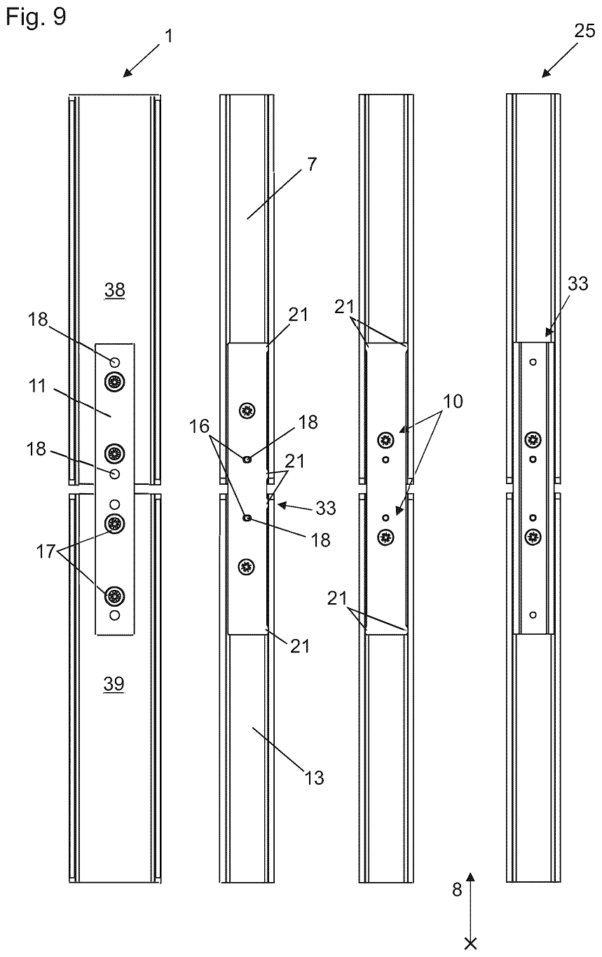

FIG. 9 shows the fixing options according to FIG. 8 in top view, wherein the connecting device 11 can have an unlimited number of protrusions 21 or conical embossings 33 for connection to the profiled pieces 7, 13.

The first profiled piece 7 is arranged as a butt joint with the adjacent additional profiled piece 13. If two additional profiled pieces 13 are present, these are generally also positioned butt to butt with each other.

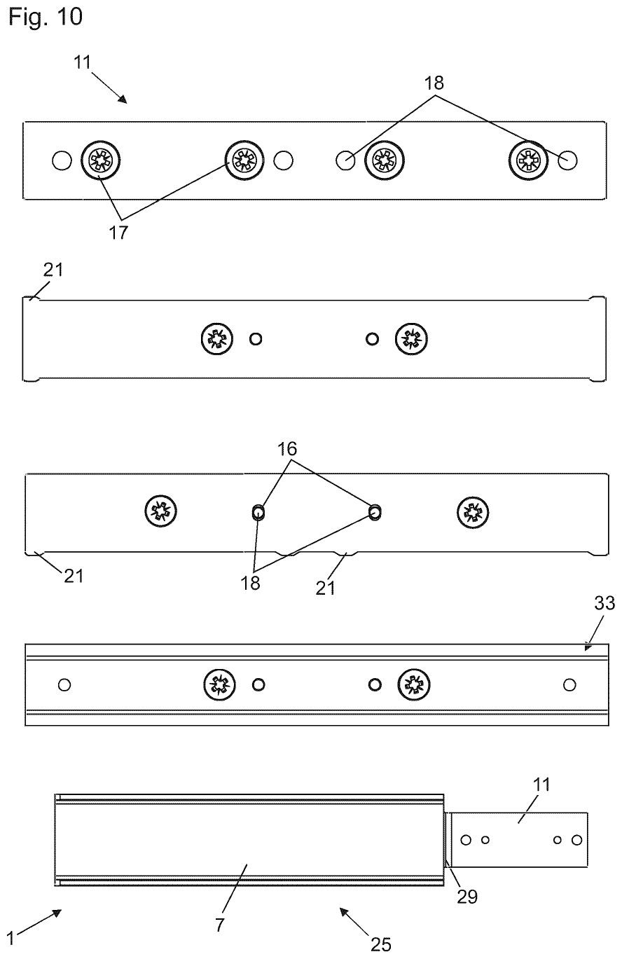

FIG. 10 shows five preferred embodiments of connecting devices 11, which are particularly preferably used for hinge strips 25.

The upper four connecting devices 11 correspond to those shown in FIG. 8 and FIG. 9, wherein the lowermost connecting device 11 comprises a Z-shaped bend 29 and can be materially bonded to the first profiled piece 7.

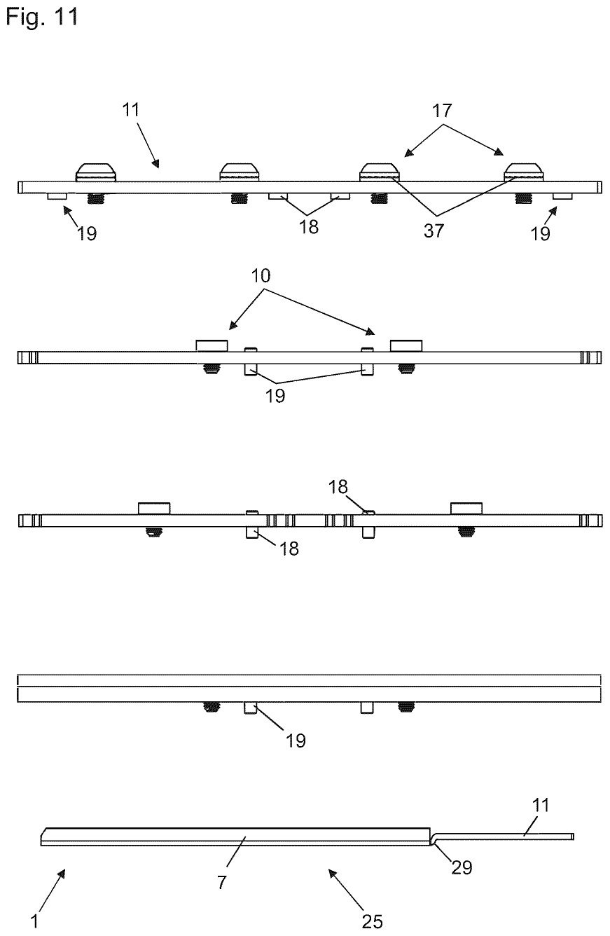

FIG. 11 differs from FIG. 10 only in that the connecting devices 11 are shown rotated by 90 degrees.

The number of fixing means such as screw connections 10 - in particular self-threading screws 17—, dowel pins 18, embossing studs 19, openings 20 and bulges 21 can be selected depending on the requirements of the profiled section 1, wherein this measure is not limited to a profiled section 1 in the form of a hinge strip 25.

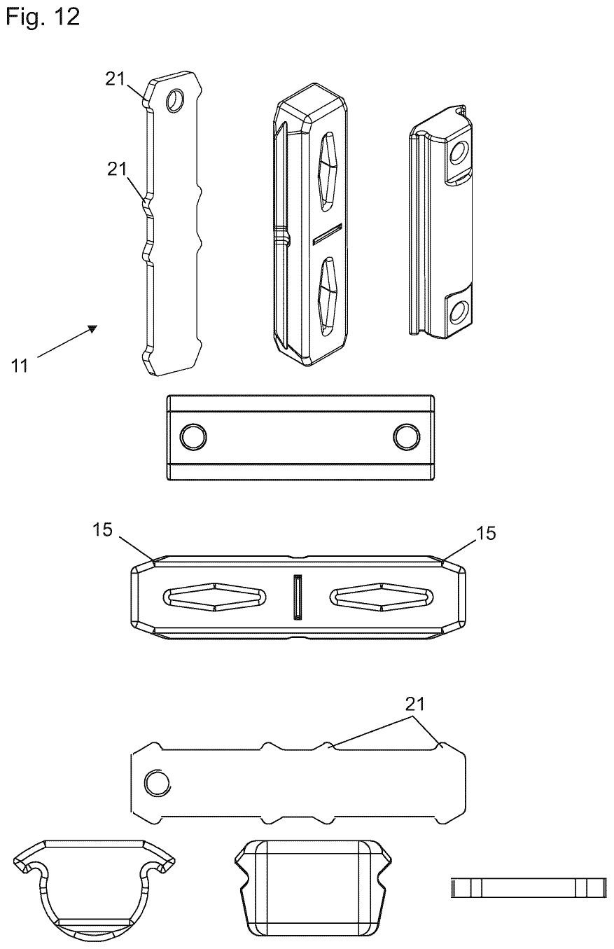

FIG. 12 shows three preferred connecting devices 11 in different views, which are particularly preferably used in cover strips 27.

The left connecting device 11 is plate-shaped and made of plastic (other materials, such as metals, are possible) and has protrusions 21 which can be used to clamp the profiled pieces 7, 13.

The central connecting device 11 and the right connecting device 11 (at the top of the illustration) are essentially cuboid in shape and made of plastic and can support a U-profiled section shape 22 of the profiled section 1 against deformation.

The connecting device 11 can be inserted into the first profiled piece 7 or the additional profiled piece 13 without tools—in particular by means of a friction connection.

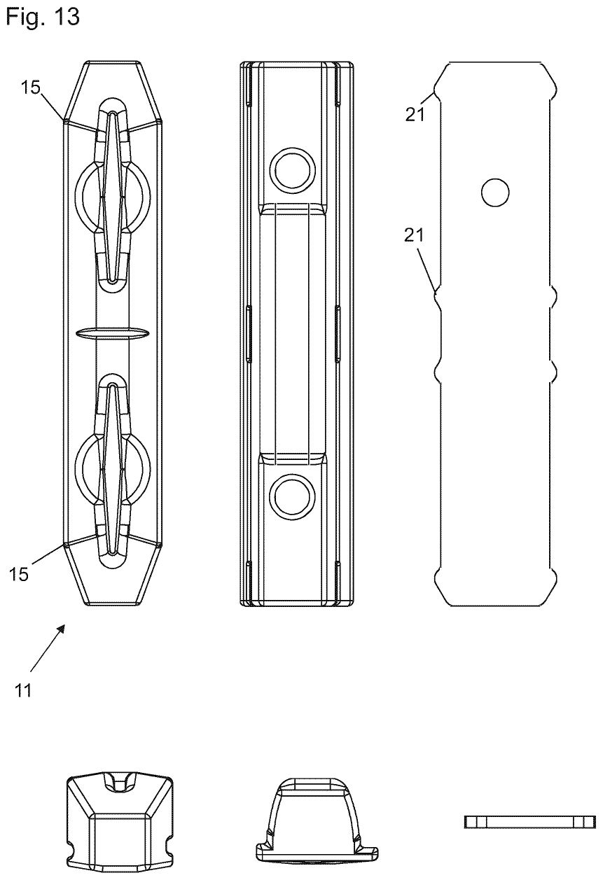

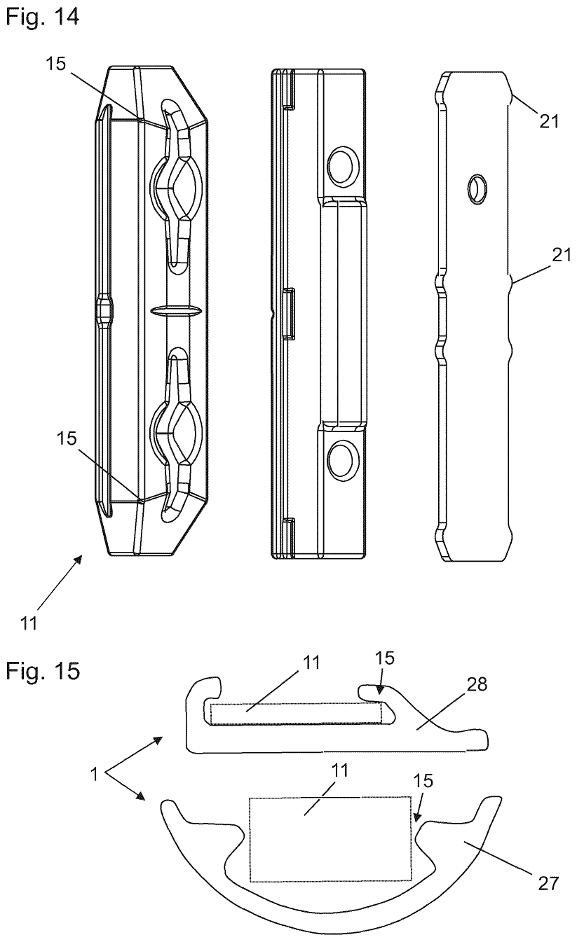

FIG. 13 and FIG. 14 show three preferred embodiments of a connecting device 11, which are particularly preferably used in the connection of profiled pieces 7, 13 of a hinged cover 28.

The connecting devices 11 are made of plastic and can be connected to the profiled pieces 7, 13 of the profiled section without tools via a clamping connection 15 or plug connection—in particular by means of a force-fit connection.

Preferably the connecting device 11 is fixed by means of a screw connection 10, although this is not absolutely necessary.

FIG. 15 shows in the upper illustration a preferred geometry of a profiled section 1 of a hinged cover 28 with a particularly preferred positioning of the connecting device 11, and in the lower illustration a preferred geometry of a profiled section 1 of a cover strip 27 with a particularly preferred positioning of the connecting device 11.

1. A method for installing a profile section with a total longitudinal extension, preferably of at least 1200 mm, on a support structure for a translational guide system for a door assembly of a piece of furniture for concealing an additional piece of furniture, the method comprising:
a first profiled piece is connected to a connecting device in a preparatory step, wherein the connecting device is integrally formed and/or is connected to the first profiled piece at precisely one first fixation surface,
the first profiled piece is removed from a storage device, preferably a transport pallet, together with the connecting device which projects, preferably exclusively, in the longitudinal direction beyond a longitudinal extension of the first profiled piece and is preinstalled, preferably by means of at least one screw connection and/or in a detachable manner, wherein the longitudinal extension of the first profiled piece with the connecting device arranged thereon is a maximum of 1200 mm,
at least one additional profiled piece is removed from a, preferably the, storage device with a longitudinal extension of the at least one additional profiled piece adapted to the total longitudinal extension of the profile section, and is connected, preferably via exactly one additional fixation surface oriented coplanar to the first fixation surface and/or screwed by means of at least one screw connection and/or clamped by means of at least one clamping connection or plug connection, to the connecting device preinstalled on the first profiled piece, wherein the longitudinal extension of the at least one additional profiled piece is a maximum of 1200 mm, wherein it is preferably provided that a further preinstalled connecting device is arranged on the at least one additional profiled piece,
the first profiled piece and the at least one additional profiled piece or the profiled section are arranged on the support structure.

2. The method according to claim 1, wherein the first profiled piece is positioned with a butt joint with the adjacent additional profiled piece and/or two adjacent additional profiled pieces.

3. The method according to claim 1, wherein the total longitudinal extension of the profiled section is at least 2400 mm and the profiled section is formed from at least, preferably exactly, three profiled pieces, wherein it is preferably provided that at least two of the at least three profile pieces comprise a preinstalled connecting device.

4. The method according to claim 1, wherein at least one of the profiled pieces and/or the at least one connecting device has at least one elongated hole oriented in the longitudinal direction, wherein the at least two profiled pieces are positioned relative to each other via the at least one elongated hole in such a way that a predefined total longitudinal extension of the profiled section is obtained.

5. The method according to claim 1, wherein the at least one connecting device is arranged via at least one self-threading screw, preferably with underhead teeth, and/or at least one dowel pin and/or at least one embossed stud as a centering lug on one of the profiled pieces, wherein it is preferably provided that at least one profiled piece and/or the at least one connecting device comprises at least one opening for chip release for the at least one self-threading screw.

6. The method according to claim 1, wherein the at least two profiled pieces are aligned orthogonally to the longitudinal direction via at least two protrusions on the at least one connecting device and/or via at least one elongated hole oriented orthogonally to the longitudinal direction.

7. The method according to claim 1, wherein the at least one connecting device is inserted into the at least two profiled pieces without the use of tools and/or a U-shaped profile of the at least two profiled pieces is supported by the at least one connecting device.

8. The method according to claim 1, wherein the profiled section is arranged on the support structure to have a structure of:
a running rail for movement of the door assembly transverse to a receiving shaft of the support structure, or
a hinge strip for a hinge support of the support structure, or
a hinge support for connecting a hinge strip to the support structure, or
a cover strip for covering a running rail, or
a hinged cover for at least partially covering a receiving shaft of the support structure and/or a gap in the door assembly.

9. A profiled section for a support structure with a translational guide system for a door assembly of a piece of furniture for concealing another piece of furniture, wherein the profiled section has a total longitudinal extension, preferably of at least 1200 mm, wherein the profiled section comprises a first profiled piece with a connecting device protruding, preferably exclusively, in the longitudinal direction beyond a longitudinal extension of the first profiled piece and preinstalled, preferably by means of at least one screw connection and/or detachably, wherein the longitudinal extension of the first profiled piece with the connecting device arranged thereon is a maximum of 1200 mm and the connecting device is integrally formed and/or connected to the first profiled piece at exactly one first fixation surface, and comprises at least one additional profiled piece with a longitudinal extension of the at least one additional profiled piece adapted to the total longitudinal extension of the profiled section, wherein the at least one additional profiled piece is connected to the connecting device preinstalled on the first profiled piece, preferably via exactly one further fixation surface oriented coplanar to the first fixation surface, preferably screwed by means of at least one screw connection and/or clamped by means of at least one clamping connection or plug connection, wherein the longitudinal extension of the at least one further profile piece is a maximum of 1200 mm, wherein it is preferably provided that a further preinstalled connecting device is arranged on the at least one additional profiled piece.

10. The profiled section according to claim 9, wherein the at least one connecting device is essentially plate-shaped and/or metallic or made of plastic, wherein it is preferably provided that the at least one connecting device comprises a Z-shaped bend.

11. The profiled section according to claim 9, wherein the at least one connecting device is of substantially cuboid form and/or is made of plastic or metal.

12. The profiled section according to claim 9, wherein the first profiled piece is positioned with a butt joint with the adjacent additional profiled piece and/or two adjacent additional profiled pieces.

13. The profiled section according to claim 9, wherein the total longitudinal extension of the profiled section is at least 2400 mm and the profiled section is formed from at least, preferably exactly, three profiled pieces, wherein it is preferably provided that at least two of the at least three profiled pieces comprise a preinstalled connecting device.

14. The profiled section according to claim 9, wherein at least one of the profiled pieces and/or the at least one connecting device has at least one elongated hole oriented in the longitudinal direction for adjusting a predefined overall longitudinal extension of the profiled section.

15. The profiled section according to claim 9, wherein the at least one connecting device is arranged via at least one self-threading screw, preferably with underhead teeth, and/or at least one dowel pin and/or at least one embossed stud as a centering lug on one of the profiled pieces, wherein it is preferably provided that at least one profiled piece and/or the at least one connecting device comprises at least one opening for chip release for the at least one self-threading screw.

16. The profiled section according to claim 9, wherein the at least two profiled pieces are aligned orthogonally to the longitudinal direction via at least two protrusions on the at least one connecting device and/or via at least one elongated hole oriented orthogonally to the longitudinal direction.

17. The profiled section according to claim 9, wherein the at least two profiled pieces and/or the at least one connecting device is designed in the form of a U-shaped sheet metal, wherein it is preferably provided that the sheet metal comprises legs of different heights and/or at least one conical embossing.

18. The profiled section according to claim 17, wherein at least one support device and/or at least one spacer sleeve is provided within the sheet.

19. The profiled section according to claim 9, wherein the profiled section is designed as a running rail for a carriage for moving the door assembly along the guide system.

20. The profiled section according to claim 9, wherein the profiled section is designed as a hinge strip for connecting the door assembly to a hinge support of the guide system.

21. The profiled section according to claim 9, wherein the profiled section is designed as a hinge support for connecting to a door assembly or a hinge strip on the guide system.

22. The profiled section according to claim 9, wherein the profiled section is designed as a cover strip for covering the guide system, wherein it is preferably provided that the cover strip comprises at least one holding device with a locking mechanism for connecting the cover strip to a running rail.

23. The profiled section according to claim 9, wherein the profiled section is designed a hinged cover for at least partially covering a receiving shaft of the support structure and/or a gap in the door assembly.

24. A piece of furniture comprising:
a support structure,
a translational guide system arranged on the support structure,
a door assembly mounted so as to be movable relative to the guide system for concealing another piece of furniture, and
the profiled section according to claim 9.
